(19) United States
(12) Patent Application Publication
(10) Pub. No.: US 2025/0153903 A1
(43) Pub. Date: May 15, 2025

(54) Storage Device

(71) Applicant: TANOS GmbH, lllertissen (DE)

(72) Inventors: Matthias Maier, Ulm (DE); Cordula Wozniak, Ulm (DE)

(21) Appl. No.: 18/838,046

(22) PCT Filed: Feb. 14, 2022
(86) PCT No.: PCT/EP2022/053509

§ 371 Date: Aug. 13, 2024

(51) Int. Cl. B65D 25/28; B25H 3/02; B65D 21/02; B65D 25/04; B65D 43/16; B65D 43/22; B65D 51/28

(52) U.S. Cl. CPC B65D 25/2858; B65D 21/0223; B65D 25/04; B65D 43/164; B65D 43/22; B65D 51/28; B25H 3/02; B65D 2543/00194

(57) ABSTRACT

A storage device, having at least one storage container which has a container housing, which has a housing front side and a housing rear side opposite the housing front side extending in a depth direction and which has a housing lower part and a container cover, which is mounted pivotably on the housing lower part in the region of the housing rear side and on the upper side of which there is arranged a carry handle, which has a U-shaped design with a carry bar and two holding limbs protruding from the carry bar at a distance from one another, the holding limbs being pivotably mounted on the container cover by their end regions opposite the carry bar, such that the carry handle is pivotable between a non-use position, resting on the container cover, and a carry position, standing up from the container cover.

### CROSS-REFERENCE TO RELATED APPLICATION

This application is the United States national phase of International Patent Application No. PCT/EP2022/053509 filed Feb. 14, 2022, the disclosure of which is hereby incorporated by reference in its entirety.

### BACKGROUND

### Field

The invention relates to a storage device, having at least one storage container which has a container housing, which has a housing front side and a housing rear side opposite the housing front side extending in a depth direction and which has a housing lower part and a container cover, which is mounted pivotably on the housing lower part in the region of the housing rear side and on the upper side of which there is arranged a carry handle, which has a U-shaped design with a carry bar and two holding limbs protruding from the carry bar at a distance from one another, the holding limbs being pivotably mounted on the container cover by their end regions opposite the carry bar, such that the carry handle is pivotable between a non-use position, resting on the container cover, and a carry position, standing up from the container cover, and a cover compartment being arranged on the upper side of the container cover, said cover compartment being equipped with a receiving space for accessory parts and/or other parts and being closable by a closure cover, the receiving space in the plan view being partly surrounded by the carry handle in the non-use position of the carry handle by engaging in the U formed by the carry handle.

### Description of Related Art

A storage device of the type mentioned in the introduction is described, for example, in EP 2 188 B1. The storage container disclosed there has a container housing with a container cover pivotably mounted on the lower part of the container housing. A cover compartment is also provided, which can be closed with a closure cover. The receiving space for the accessory parts and/or other parts extends in the depth direction of the container housing between the carry handle and the container front side. The pivot axis of the closure cover is in the region of the U-opening of the U-shaped carry handle.

US 2004/0178208 A1 discloses a container for storing crushed ice or ice cubes, which has a container housing, which has a housing lower part and a housing cover pivotably mounted on the housing lower part. In the housing cover there is a cover compartment, with a receiving space, which consists of two compartments, wherein the two compartments can be closed by a shared closure cover.

### SUMMARY

The object of the invention is to provide a storage device of the type mentioned in the introduction, which is cheaper to produce and easier to handle compared to the storage devices known from the prior art.

This object is achieved by a storage device having the features as described herein. Embodiments of the invention are set out in the dependent claims.

The storage device according to the invention is characterized in that the U formed by the carry handle in its non-use position points with its U-opening in the direction of the housing rear side, and the cover compartment extends in the depth direction of the container housing between the carry handle and the housing rear side.

The cover compartment is set back in the direction of the housing rear side and is located behind the carry bar of the carry handle when the carry handle is in the non-use position. The cover compartment is also positioned away from the front edge of the container cover such that there is a clear separation between the cover compartment on the one hand and the container cover front surface, whereby handling of the container cover to open the container by pivoting up the container cover is not hindered by the cover compartment. It is not possible to accidentally open the cover compartment instead of the container cover. In order to open the closure cover of the cover compartment, the user has to reach into the central region of the container cover in a targeted manner.

In one embodiment of the invention, the receiving space of the cover compartment is delimited by an annular receiving space peripheral wall, which consists of a receiving space front wall, a receiving space rear wall and two receiving space side walls. The receiving space peripheral wall is preferably part of the container cover, in particular the receiving space peripheral wall is formed at the same as the container cover is produced.

In one embodiment of the invention, the receiving space rear wall is designed in the form of a narrow strip. An outer surface of the receiving space rear wall facing away from the receiving space expediently forms a section of the container cover rear surface. The receiving space front wall and/or the receiving space side walls are also expediently designed in the form of a narrow strip.

In one embodiment of the invention, the closure cover and the receiving space have a square or rectangular shape.

In one embodiment of the invention, the closure cover can be moved between a closed position closing the receiving space and an open position providing access to the receiving space.

The closure cover is expediently mounted on the container so as to pivot between the closed position and the open position by means of a pivot mounting device. This embodiment has the advantage that the closure cover is securely mounted on the container cover. However, in principle it would also be possible to design the closure cover as a detent cover, which can be moved between a closed position engaged on the container cover and an open position removed from the container cover.

Particularly preferably, the closure cover in its closed position engages between the two side walls of the receiving space and rests both on the rear wall and on the side wall in such a way that the closure cover upper side in the closed position is aligned with the container cover upper side. The closure cover can therefore be arranged in or below the plane of the upper side of the container cover in its closed position.

The closure cover expediently has a front edge, which is arranged between the two holding limbs of the carry bar when the closure cover is in the closed position. The closure cover also has a rear edge, which is expediently arranged in the region of the container cover rear surface when the closure cover is in the closed position.

Particularly preferably, the container cover has two bearing slots spaced apart from one another in the width direction of the container, which are open upwards towards the container cover upper side and towards the container cover rear surface, and in which the closure cover engages with bearing arms belonging to the pivot mounting device. This makes it possible to fit the closure cover relatively easily and therefore cost-effectively from the container rear side by inserting the bearing arms into the bearing slots open at the rear.

In one embodiment of the invention, a cylindrical bearing eye is respectively formed on the bearing arms and is pivotably received in the associated bearing slot in such a way that the pivot axis of the closure cover running in the width direction runs through the two bearing eyes. It is also possible that a trough-shaped recess or trough is formed on the bottom of a respective bearing slot, in which an associated bearing eye is received.

In one embodiment of the invention, a respective bearing slot has a slot mouth on the container rear surface, the vertical extent of which is smaller than the vertical extent of the associated bearing eye, wherein the bearing eye is elastically deformable in such a way that it passes through the slot mouth and resumes its original shape after passing through the slot mouth.

Particularly preferably, the bearing eyes respectively have a slot open towards the free end of the bearing arms and oriented transverse to the pivot axis, which slot separates the bearing eye into two bearing eye sections, which can be bent towards each other in an elastically deformable manner as a result of the slot.

In one embodiment of the invention, the closure cover has a cover element, which has a front edge facing the carry handle in the closed position of the closure cover, wherein a locking element is arranged on the cover element in the region of the front edge and engages with the container cover, in particular the receiving space front wall, in the closed position. The locking element can expediently be moved between a locking position locking the closure cover in the closed position and an unlocking position.

Particularly preferably, the locking element is preloaded into the locking position by means of a spring element and is to be pressed in the direction of the unlocking position against the spring force of the spring element for unlocking. Such an embodiment of the locking element has the advantage that the closed position of the closure cover is held relatively securely such that the closure cover cannot pop open unintentionally. Nevertheless, the locking element can be actuated relatively easily by pressing against the spring force of the spring of the spring element in order to unlock the closure cover.

In one embodiment of the invention, the end regions of the holding limbs provided for pivotal mounting engage around the receiving space side walls and are hinged to the associated receiving space side walls.

Particularly preferably, a locking mechanism is associated with the carry handle and is designed to lock the carry handle in its non-use position in a non-pivotable releasable manner.

Particularly preferably, the locking mechanism has detent means which automatically engage or disengage depending on the pivot direction of the pivot movement when a corresponding actuating force is applied to the carry handle.

The detent means expediently have at least one nose-shaped locking projection arranged on the container cover.

Particularly preferably, the locking projection is arranged on a wall region of the container cover that lies in the region of the container front side and is formed on the other side of the carry bar of the carry handle than the cover compartment when the carry handle is in the folded-in non-use position. A single locking projection is expediently provided, which is arranged approximately in the centre of the width extent of the container on the wall region of the container cover.

In one embodiment of the invention, the storage device comprises a compartment dividing device for dividing the receiving space of the cover compartment into a plurality of partial compartments.

Particularly preferably, the compartment dividing device has a plurality of fixing slots arranged on the receiving space peripheral wall and a plurality of web-shaped partitions that can be releasably inserted into the fixing slots and fixed there. The partitions can be different lengths, which means that partial compartments of different sizes can be customized. It is also possible for base projections to be releasably attached to the base of the receiving space, which base projections can be coupled to partitions and serve to reinforce them. It is also possible to attach node elements to the base projections, which enable a partition wall connection across corners.

In one embodiment of the invention, the storage device comprises a closure cover securing device for securing the closure cover in its open position on the container cover. This ensures that in its closed position, the closure cover is relatively well supported on the container cover in the region of the closure cover pivot axis in particular against lifting. The closure cover securing device can, for example, have corresponding securing projections that engage with one another when the closure cover is in the closed position and corresponding securing recesses. It is, for example, possible that the securing recesses are located on the outer surface of the receiving space rear wall. Correspondingly, securing projections are then provided on the rear edge of the closure cover.

In one embodiment of the invention, the storage device comprises a plurality of storage containers, which on their container housing respectively have a lower coupling device in the region of the lower side and an upper coupling device in the region of the upper side, wherein these two coupling devices are adapted to one another in such a way that storage containers stacked directly on top of one another in a vertical direction can be releasably coupled to one another in a manner that prevents them from being separated from each other thanks to the interaction of the upper coupling device of the respective lower storage container and the lower coupling device of the respective upper storage container.

### BRIEF DESCRIPTION OF THE DRAWINGS

The terms Fig., Figs., Figure, and Figures are used interchangeably in the specification to refer to the corresponding figures in the drawings.

Preferred exemplary embodiments of the invention are illustrated in the drawing and explained in more detail below. In the drawings,

FIG. 1 is a perspective view of a first exemplary embodiment of the storage device according to the invention with a single storage container,

FIG. 2 is a perspective rear view of the storage container shown in FIG. 1, wherein the open position of the container cover is indicated by dashed lines,

FIG. 3 is a plan view of the storage container shown in FIG. 1,

FIG. 4 shows a section through the storage container shown in FIG. 3 along the line IV-IV, wherein an open position of a closure cover of the cover compartment arranged in the container cover is shown by dashed lines,

FIG. 5 is a perspective rear view of the storage container according to FIG. 1 with an open closure cover of the cover compartment,

FIG. 6 is a plan view of the storage container according to FIG. 3 with an open closure cover and a compartment dividing device marked by dashed lines,

FIG. 7 shows a section according to FIG. 4, wherein only the container cover with an open closure cover of the cover compartment is shown here,

FIG. 8 shows an enlarged view of detail VIII shown in FIG. 7,

FIG. 9 shows the detail shown in FIG. 8, wherein the bearing arms of the closure cover have not yet been inserted into the associated bearing slots here and

FIG. 10 is a perspective view of a second exemplary embodiment of the storage device according to the invention with a plurality of storage containers.

### DETAILED DESCRIPTION OF PREFERRED EMBODIMENTS

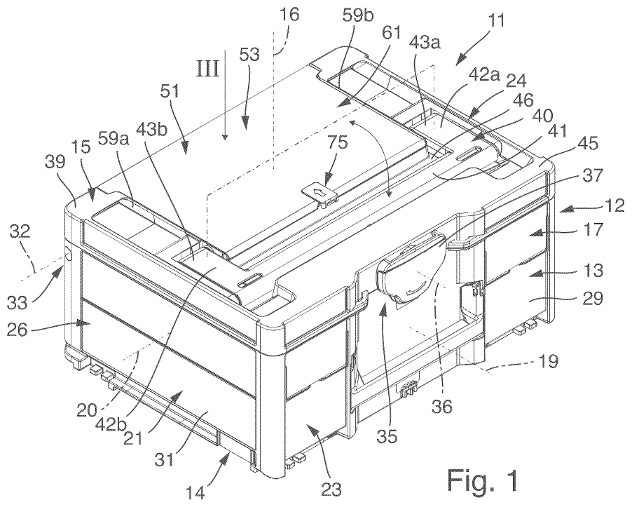

FIGS. 1 to 9 show a first exemplary embodiment of the storage device 11 according to the invention. According to a first exemplary embodiment, the storage device 11 comprises a single storage container 12, the basic structure of which can be seen in FIGS. 1 to 9 in an advantageous embodiment.

The storage container 13 has a container housing 13 with preferably an at least substantially rectangular layout, which is shown in FIGS. 1 to 6.

The container housing 13 has a vertical axis 16 extending between a lower side 14 and an upper side 15, the orientation of which defines a vertical direction which bears the same reference numeral. It also has a depth axis 19 perpendicular to the vertical axis 16 and running between a housing front side 17 and a housing rear side 18 as well as a width axis 20 perpendicular to both the vertical axis 16 and the depth axis 19. The axis direction of the depth axis 19 defines a depth direction which bears the same reference numeral, whilst the axis direction of the width axis defines a width direction of the container housing 13 which bears the same reference numeral.

The aforementioned rectangular layout runs in a plane perpendicular to the vertical axis 16.

The container housing 13 has a housing wall 21, which delimits a storage space 22 formed in the inside of the housing and shown by way of example in FIG. 4. Any objects to be stored can be accommodated in the storage space 22, for example tools and in particular power tools.

The container housing 13 expediently has a housing lower part 23 and a container cover 24 pivotably mounted on the housing lower part 23. The housing wall 21 consists of walls of the housing lower part 23 and the container cover 24.

In the preferably box-shaped lower housing part 23, the housing wall 21 consists of a base wall 25 closing off the storage space 22 at the lower side 14 and a lower part peripheral wall 26 projecting upwards from the outer edge of this base wall 25 in the vertical direction 16. The lower part peripheral wall 26 surrounds the storage space 22 in a ring around the vertical axis 16, wherein at its upper side 15 opposite the base wall 25 it has an upper end section 28 bordering an access opening 27 for the storage space 22. Objects can be placed in the storage space 22 and removed from the storage space 22 through the access opening 27.

The lower part peripheral wall 26, which is integral with the base wall 25, consists of a lower part front wall 29 oriented perpendicular to the vertical axis 16, a lower part rear wall opposite the lower part front wall 29 in the depth direction 19 and two lower part side walls 31. The lower part side walls 31 are opposite one another in the width direction 20 and respectively connect the lower part front wall 29 to the lower part rear wall 30. The lower part front wall 29 and the lower part rear wall 30 respectively extend substantially in a plane perpendicular to the depth axis 19. The lower part side walls 31 respectively extend substantially in a plane perpendicular to the width axis 20.

The entire lower part peripheral wall 26 and the base wall 25 are formed integrally with one another. The storage container 12 can, for example, be manufactured as a plastic injection-moulded part.

The container cover 24 is associated with the access opening 27 and is mounted, preferably in the region of the lower part rear wall 30, i.e. in the region of the housing rear side 18, so as to be pivotable relative to the lower housing part 23 about a pivot axis 32 extending in the width direction 20. The pivot mounting means 33 defining the pivot axis 32 are preferably arranged on the rear corner regions of the lower part peripheral wall 26 respectively connecting a lower part side wall 31 to the lower part rear wall 30, in particular with only a small vertical distance to the access opening 27.

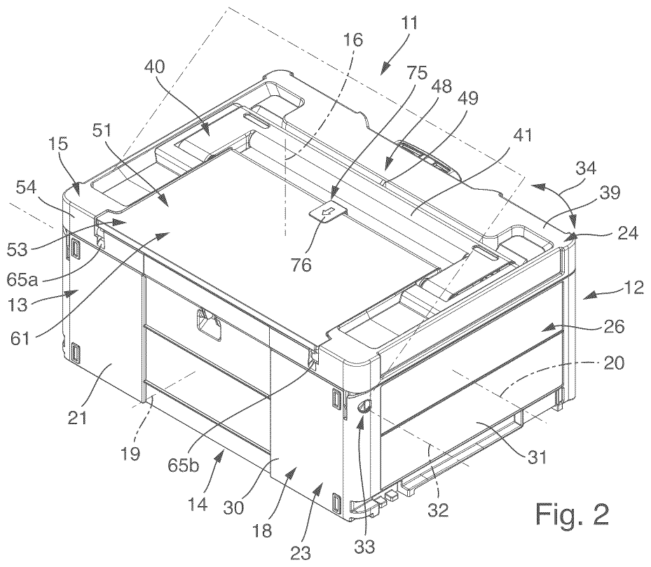

As part of a pivot movement 34 indicated by a double arrow in FIG. 2, the container cover 24 can be optionally positioned in a closed position resting on the upper end section 28 of the lower part peripheral wall 26 and closing the access opening 27 or in various open positions pivoted upwards to various extents. In the open positions, the access opening 27 is accessible with a varying opening cross-section depending on the selected opening pivot angle.

The closed position of the container cover 24 can be expediently releasably locked. For this purpose, suitable locking means 35, which can be actuated manually, are located, by way of example, in the region of the housing front side 17 on the outside of the container housing 13. The locking means 35 preferably comprise a rotary latch 37 mounted in the region of the housing front side on the container cover 24 so as to rotate about an axis of rotation 36 parallel to the depth axis 19 and a locking projection 38 arranged on the outside of the lower part front wall 29 of the housing lower part 23. The rotary latch 37 can be rotated when the container cover 24 is in the closed position state such that it is either in or out of locking engagement with the associated locking projection 38.

The storage container 12 illustrated by way of example contains only one storage space 22 closed by the container cover 24 in an openable manner. In one exemplary embodiment (not shown), at least one drawer that can be pulled out if necessary is additionally arranged in the housing lower part 23, and provides an additional storage space.

As shown in particular in FIG. 1, a carry handle 40 is arranged on the container cover upper side 39, which has a U-shaped design with a carry bar 41 and two holding limbs 42a, 42b protruding from the carry bar 41 at a distance from one another. The holding limbs 42a, 42b are respectively pivotably mounted on the container cover 24 with their end regions 43a, 43b opposite the carry bar 41 such that the carry handle 41 is pivotable between a non-use position (FIG. 1), resting on the container cover 24, and a carry position (not shown), standing up from the container cover 24, in which the user can grasp the carry bar 41 and thus carry and transport the container in a horizontal position.

As shown in particular in FIG. 1, the upper cover wall 45 of the container cover 24 belonging to the housing wall 21 has an upper wall recess 46 on the outside, in which the carry handle 40 is rotatably mounted and in which the carry handle 40 is preferably completely recessed when assuming its non-use position. This is particularly advantageous in connection with the fact that a plurality of storage containers 12 can be stacked on one another and can be firmly connected to one another in a releasable manner. In the use position or carry position, the carry handle protrudes upwards out of the upper wall recess 46, wherein the carry bar 41 is far enough away from the upper cover end surface 47 to enable the storage container 12 to be gripped by one hand for carrying.

As shown in particular in FIG. 1, the U-opening 44 of the U-shaped carry handle 40 points in the direction of the housing rear side 18 in its non-use position. As shown in particular in FIG. 2, a locking mechanism 48 is associated with the carry handle 40 and is designed to lock the carry handle 40 in its non-use position in a non-pivotable releasable manner. The locking mechanism 48 prevents the carry handle which is in the non-use position from performing uncontrolled pivot movements relative to the container housing 13, for example when the storage container is handled without using the carry handle 40. The locking mechanism 48 is expediently designed as a detent device, which automatically engages or disengages with a snap effect depending on the pivot direction of the pivot movement when a corresponding actuating force is applied to the carry handle 40. The detent intensity is sufficiently high to prevent automatic engagement or disengagement when the storage container 12 is handled as intended. However, it is sufficiently low to enable engagement or disengagement by hand alone without an extraordinary effort.

The pivot angle of the carry handle 40 between the non-use position and the use position or carry position is expediently at least substantially 90° As shown in particular in FIG. 2, the locking mechanism 48 designed as a detent device has a locking projection 49 formed in particular in one piece with the housing wall 21. The locking projection 49 is arranged on a front wall region 50 of the container cover 24 lying in the region of the housing front side. A single locking projection 49 is expediently provided, into which the carry handle 40 is engaged in its non-use position. The locking projection 49 is expediently located approximately in the width direction 20 in the centre of the container housing 13. When the carry handle 40 is in the non-use position, the locking projection 49 is associated with a longitudinal side of the carry bar 41, which faces away from the U-opening 44 of the carry handle 40.

As shown in particular in FIGS. 1, 2 and 5, a cover compartment 51 is arranged on the upper side of the container cover 24, i.e. on the container cover upper side 39, said cover compartment being equipped with a receiving space 52 for accessory parts (not shown) and/or other parts and being closable by a closure cover 52.

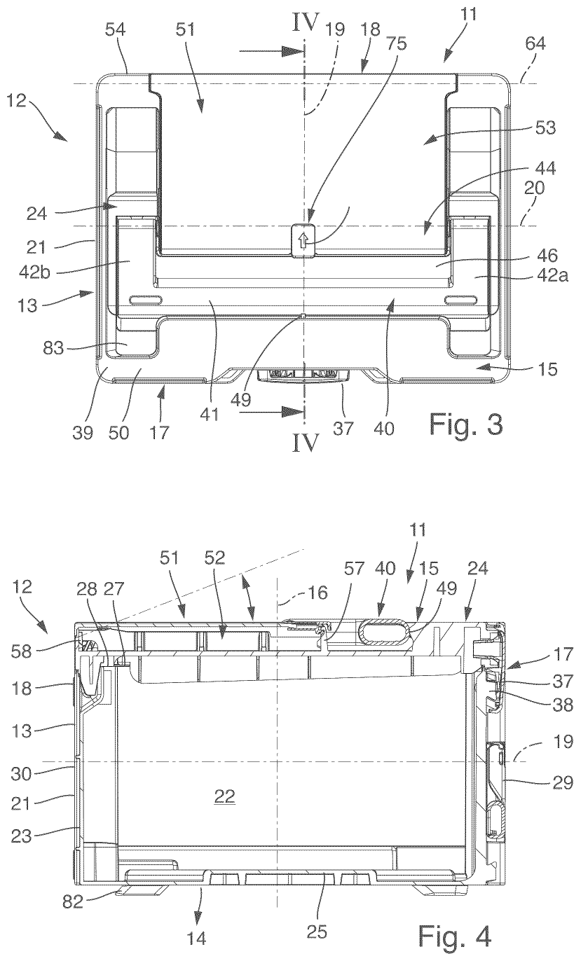

As shown in particular in FIG. 3, the receiving space (closed with the closure cover 42 in FIG. 3) in the plan view is partly surrounded by the carry handle 40 in the non-use position of the carry handle 40 by engaging in the U formed by the carry handle 40.

As shown further in FIG. 3, the U formed by the carry handle 14 in its non-use position points with its U-opening 44 in the direction of the housing rear side 18 in such a way that the cover compartment 51 extends in the depth direction 19 of the container housing 13 between the carry handle 40 and the housing rear side 18.

In the width direction 20, the cover compartment 51 is therefore delimited on the left and right by respectively one holding limb 42a, 42b of the carry holder, whilst it sits behind the carry bar 41 of the carry handle 40 in the depth direction as seen from the front side 17 and extends in the direction of the housing rear side 18. The cover compartment 51 expediently extends in the depth direction 19 substantially up to the housing rear side, i.e. up to the container cover rear surface 54.

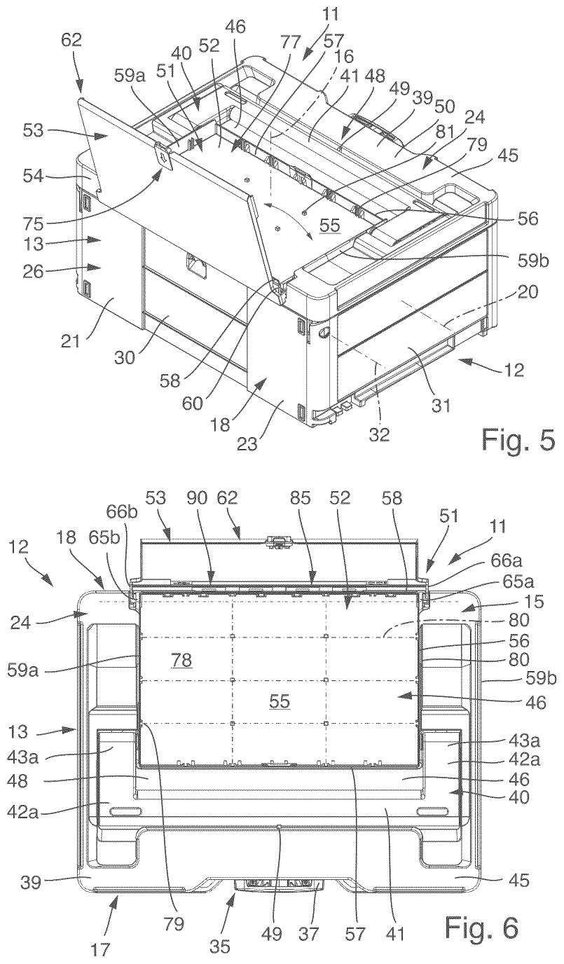

FIGS. 5 and 6 show an exemplary embodiment of the receiving space 52 of the cover compartment 51. The receiving space is rectangular in the example. The receiving space 52 is delimited on the bottom by a receiving space base 55 and at the side by an annular receiving space peripheral wall 56. The annular receiving peripheral wall 56 consists of a receiving space front wall 57, a receiving space rear wall 58 and two receiving space side walls 59a, 59b. The annular receiving space peripheral wall 56 expediently constitutes part of the container cover 54, by being formed at the same as the container cover 24 is produced, for example.

It is for example possible that the upper wall recess 56 of the container cover 24 extends in the depth direction 19 up to the container cover rear surface 54 and the cover compartment 51 is arranged in the upper wall recess 46 of the container cover 24 and the annular receiving space peripheral wall 56 projects upwards from the base of the upper wall recess in the vertical direction.

As shown in particular in FIG. 6, the receiving space rear wall 58 is designed in the form of a narrow strip. An outer surface 60 of the receiving space rear wall 54 facing away from the receiving space 52 forms a section of the container cover rear surface 54. In other words, the receiving space 52 of the cover compartment 51 extends in the depth direction 16 up to the container cover rear surface 54.

The other walls of the receiving space peripheral wall 56, i.e. the receiving space front wall 57 and the two receiving space side walls 59a, 59b are also expediently designed in the form of a narrow strip.

The closure cover 53 serves to close the cover compartment 51. It can be moved between a closed position 61 (for example FIG. 1) closing the receiving space 52 and an open position 62 (FIG. 5) providing access to the receiving space 52.

In the example shown, the closure cover 53 is mounted on the container cover 24 so as to pivot about a closure cover pivot axis 64 between the closed position 61 and the open position 62 with a pivot mounting device 63. The closure cover pivot axis 64 is in the region of the container cover rear surface 54.

As shown in particular in FIG. 1, the closure cover 53 in its closed position 61 engages between the two receiving space side walls 59a, 59b and rests both on the receiving space rear wall 58 and on the receiving space front wall 57 in such a way that the closure cover upper side 65 in the closed position 61 is substantially aligned with the container cover upper side 39.

As shown in particular in FIG. 2, the container cover 24 has two bearing slots 65a, 65b spaced apart from one another in the width direction 20, which are open upwards towards the container cover upper side 39 and towards the container cover rear surface 54, and in which the closure cover 53 engages with bearing arms 66a, 66b belonging to the pivot mounting device 63.

The closure cover 53 has a cover element 67 that may be made from transparent material and has a front edge 68 and a rear edge 69 arranged opposite.

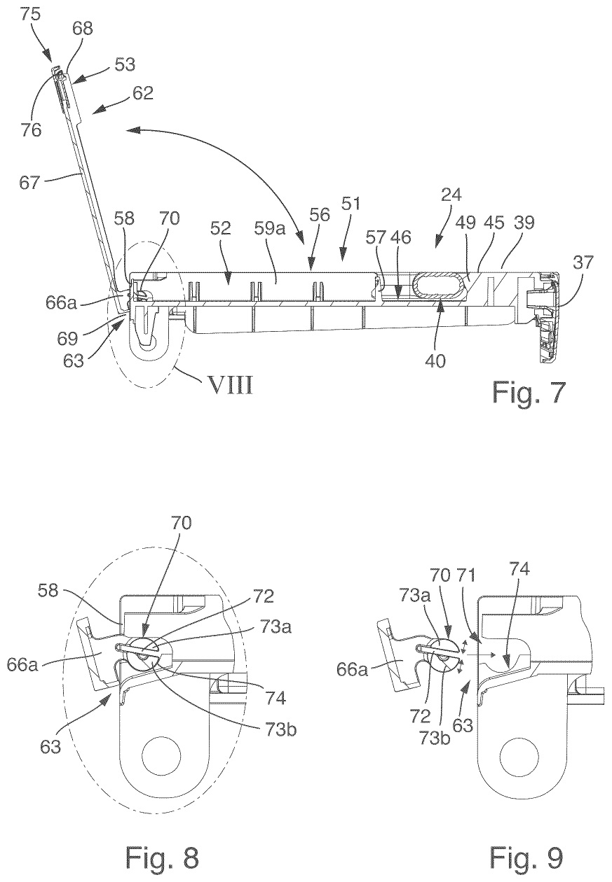

As shown in particular in FIG. 7, the two bearing arms 66a, 66b are arranged on the rear edge 69 of the cover element 67. For example, connected in one piece there with the cover element 67, for example formed at the same time as the cover element or closure cover is manufactured.

As shown in particular in FIGS. 8 and 9, cylindrical bearing eyes 70 are respectively formed on the bearing arms 66a, 66b. A respective cylindrical bearing eye 70 is pivotably received in the associated bearing slot 65a, 65b in such a way that the closure cover pivot axis 64 of the closure cover 53 running in the width direction runs through the two bearing eyes 70. The bearing eyes 70 are respectively located at the free ends of the associated bearing arms 66a, 66b and are in particular connected in one piece there with the rest of the bearing arm 66a, 66b, for example formed at the same time as the bearing arm, which is expediently connected in one piece with the cover element, is manufactured.

As shown in particular in the combined view of FIGS. 8 and 9, the bearing slot 65a, 65b has a slot mouth 71 on the container cover rear surface 54, the vertical extent of which is smaller than the vertical extent of the associated bearing eye 70, wherein the bearing eye 70 is elastically deformable in such a way that it passes through the slot mouth 71 and resumes its original shape after passing through the slot mouth 71.

A respective bearing eye 70 expediently has a slot 72 open towards the free end of the bearing arms 66a, 66b and oriented transverse to the closure cover pivot axis 64, which slot separates the bearing eye 70 into two bearing eye sections 73a, 73b, which can be bent towards each other in an elastically deformable manner as a result of the slot 72.

As shown in the combined view of FIGS. 8 and 9, it is possible to bring the closure cover with the bearing arms in front up to the slot mouth 71 of the bearing slot 65a, 65b open towards the rear, i.e. towards the container cover rear surface 54, wherein the bearing eyes 70 come into contact with the slot mouth 71 and are then pressed together by further force application in the direction of the housing front side 17, wherein the bearing eye sections 73a, 73b are pressed towards each other such that the bearing eyes can pass through the slot mouth and the bearing eyes 70 come to rest in a semi-circular trough 74 provided for this purpose.

In the position shown in FIG. 8, the bearing eyes 70 are rotatably mounted in the associated semi-circular troughs 74 such that the closure cover can be pivoted between the closed position 61 and the open position 62 with the bearing eyes in the associated troughs performing a relative rotary movement in relation to the stationary troughs.

As shown in particular in FIGS. 7 to 9, the rear edge 69 of the cover element 67 is supported on the container cover rear surface 54 and thus determines the opening angle of the closure cover 53, which is in particular >90°.

It is possible to release the closure cover 53 from the container cover 24 in a simple, non-destructive manner from its mounting position shown in FIGS. 7 and 8. By virtue of the fact that the rear edge 69 of the cover element 67 is supported on the container cover rear surface 54, it is possible to use the cover element 67 as a lever, wherein when force is applied in an opening direction above the maximum opening angle, the slot 72 between the two bearing eye sections 73a, 73b is oriented in the tensile direction, whereby the bearing eyes can snap out of their mounting in the associated recesses 74 during levering.

As already mentioned, the closure cover 53 has a cover element 67, which has a front edge 68 facing the carry handle 40 in the closed position of the closure cover 53. A locking element 75 is arranged on the cover element 67 in the region of the front edge and engages with the container cover 24, in particular the receiving space front wall 57, in the closed position 61.

The locking element 75 can be moved between a locking position locking the closure cover 53 in the closed position 61 and an unlocking position.

As shown in particular in FIG. 1, the locking element has a locking slide 76, which is preloaded in the locking position by means of a spring element (not shown) and is to be pressed in the direction of the unlocking position against the spring force of the spring element for unlocking.

As shown in particular in FIG. 1, and also previously described, the carry handle 40 is pivotable between a non-use position, resting on the container cover 24, and a carry position, standing up from the container cover 24. As further shown in FIG. 1, the end regions 43a, 43b of the holding limbs 42a, 42b of the carry handle 40 provided for pivot mounting are arranged such that they engage around the receiving space side walls 59a, 59b and are hinged on one side to one and on the other side to the other receiving space side wall 59a, 59b.

As shown in particular in FIGS. 5 and 6, the storage device 11 has a compartment dividing device 77 for dividing the receiving space 52 of the cover compartment 51 into a plurality of partial compartments 78.

The compartment dividing device 77 has a plurality of fixing slots 79 arranged on the receiving space peripheral wall and a plurality of web-shaped partitions 80 that can be releasably inserted into the fixing slots 79 and fixed there. The partitions 80 can be different lengths such that depending on the type of partition 80 used, partial compartments 78 with different dimensions can be created. As shown in particular in FIG. 5, base projections 81 can be provided on the receiving space base 55 projecting upwards therefrom, which serve to reinforce the inserted partitions 80 by engaging in particular in designated recesses provided on a lower side of the partition 80. Furthermore, the base projections 81 can also serve to accommodate a node element (not shown), whereby partial compartments 78 can also be created, which do not run over the entire width or depth of the receiving space 52.

The storage device 11 further has a closure cover securing device 85 for securing the closure cover 53 in its closed position 51 against lifting in the region of the closure cover pivot axis 64. The closure cover securing device 85 expediently has corresponding securing projections and securing recesses, wherein in particular the securing recesses are formed on the outside of the receiving space rear wall and the securing projections are formed in the region of the rear edge 69 of the closure cover 53.

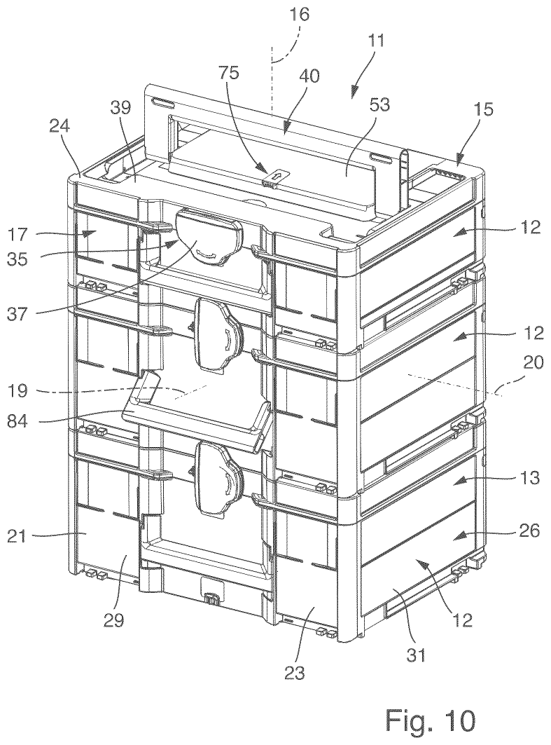

FIG. 10 shows a second exemplary embodiment of the storage device according to the invention, in which a plurality of storage containers 12 are stacked on top of one another in the vertical direction 16, resulting in a stack of containers in this example consisting of two or more, in particular three storage containers 12 stacked on top of one another, as shown by way of example in FIG. 10. When stacked, a respective upper storage container 12 sits with its lower side 14 on the upper side 15 of another storage container 12 arranged below it.

Each storage container 12 expediently has a lower coupling device 82 in the region of its lower side 14, which is designed in the manner shown in FIG. 4, for example. In addition, each storage container 12 has an upper coupling device 83 on the upper side 15, whose preferred embodiment is shown in FIG. 1, for example. The two coupling devices 82, 83 are adapted to one another in such a way that the storage containers 12 stacked directly on top of one another can be releasably coupled to one another in a manner that prevents them from being separated from each other thanks to their interaction. Such a coupled state is shown in FIG. 10. The stack of containers can then be carried and transported as a unit by means of the carry handle 40 of the uppermost storage container 12.

The aforementioned locking means 35 preferably belong at least partially to the two coupling devices 82, 83. For example, the rotary latch 37 can be rotated to a coupling position shown in FIG. 10 (between the centre and bottom storage container), in which it couples the two stacked storage containers to one another in the region of the housing front side 17 so that they cannot be separated.

In the exemplary embodiment shown, other components of the coupling device 82, 83 are formed by projections formed on the lower side 14 and recesses formed on the upper side 15. When two storage containers 12 are stacked on top of one another, the projections and recesses engage at least partially in one another, wherein they overlap or engage transverse to the vertical direction 16 and likewise cause two storage containers 12 that are stacked on top of one another to be coupled so that they cannot be separated, in particular in the region of the housing rear side 18. The projections are expediently feet used to place the storage container 12 on a surface.

As shown in particular in FIG. 1, the storage container 12 has, in addition to the carry handle that is pivotably mounted on the container cover 24 a front handle 84, which is pivotably mounted on the lower part side wall 31 on the outside. By using the front handle 84, the storage container 12 can be carried and transported in a vertical orientation, in which the vertical axis 16 is oriented horizontally.

1. A storage device, having at least one storage container which has a container housing, which has a housing front side and a housing rear side opposite the housing front side extending in a depth direction and which has a housing lower part and a container cover, which is mounted pivotably on the housing lower part in the region of the housing rear side and on the upper side of which there is arranged a carry handle, which has a U-shaped design with a carry bar and two holding limbs protruding from the carry bar at a distance from one another, the holding limbs being pivotably mounted on the container cover by their end regions opposite the carry bar, such that the carry handle is pivotable between a non-use position, resting on the container cover, and a carry position, standing up from the container cover, and a cover compartment being arranged on the upper side of the container cover, said cover compartment being equipped with a receiving space for accessory parts and/or other parts and being closable by a closure cover, the receiving space in the plan view being partly surrounded by the carry handle in the non-use position of the carry handle by engaging in the U formed by the carry handle, wherein the U formed by the carry handle in its non-use position points with its U-opening in the direction of the housing rear side, and the cover compartment extends in the depth direction of the container housing between the carry handle and the housing rear side.

2. The storage device according to claim 1, wherein the receiving space is delimited by an annular receiving space peripheral wall, which consists of a receiving space front wall, a receiving space rear wall and two receiving space side walls, wherein the receiving space peripheral wall preferably forms part of the container cover.

3. The storage device according to claim 2, wherein the receiving space rear wall is designed in the form of a narrow strip.

4. The storage device according to claim 2, wherein an outer surface of the receiving space rear wall facing away from the receiving space forms a section of the container cover rear surface.

5. The storage device according to claim 1, wherein the closure cover can be moved between a closed position closing the receiving space and an open position providing access to the receiving space.

6. The storage device according to claim 1, wherein the closure cover is mounted on the container cover so as to pivot between the closed position and the open position by means of a pivot mounting device.

7. The storage device according to claim 1, wherein the closure cover in its closed position engages between the two receiving space side walls of the receiving space and rests both on the receiving space rear wall and on the receiving space front wall in such a way that the closure cover upper side in the closed position is aligned with the container cover upper side.

8. The storage device according to claim 1, wherein the container cover has two bearing slots spaced apart from one another in the width direction, which are open upwards towards the container cover upper side and towards the container cover rear surface, and the closure cover engages with bearing arms belonging to the pivot mounting device.

9. The storage device according to claim 8, wherein a cylindrical bearing eye is respectively formed on the bearing arms and is pivotably received in the associated bearing slot in such a way that the pivot axis of the closure cover running in the width direction runs through the two bearing eyes.

10. The storage device according to claim 9, wherein the bearing slots respectively have a slot mouth arranged on the container rear surface, the vertical extent of which is smaller than the vertical extent of the associated bearing eye, wherein the bearing eye is elastically deformable in such a way that it passes through the slot mouth and resumes its original shape after passing through the slot mouth.

11. The storage device according to claim 10, wherein the bearing eyes respectively have a slot open towards the free end of the bearing arms and oriented transverse to the pivot axis, which slot separates the bearing eye into two bearing eye sections, which can be bent towards each other in an elastically deformable manner due to the slot.

12. The storage device according to claim 1, wherein the closure cover has a cover element, which has a front edge facing the carry handle in the closed position of the closure cover, wherein a locking element is arranged on the cover element in the region of the front edge and engages with the container cover, in particular the receiving space front wall, in the closed position.

13. The storage device according to claim 12, wherein the locking element can be moved between a locking position locking the closure cover in the closed position and an unlocking position.

14. The storage device according to claim 12, wherein the locking element is preloaded into the locking position by means of a spring element and is to be pressed in the direction of the unlocking position against the spring force of the spring element for unlocking.

15. The storage device according to claim 1, wherein the end regions of the holding limbs provided for pivotal mounting engage around the receiving space side walls and are hinged to the associated receiving space side wall.

16. The storage device according to claim 1, wherein a locking mechanism is associated with the carry handle and is designed to lock the carry handle in its non-use position in a non-pivotable releasable manner.

17. The storage device according to claim 16, wherein the locking mechanism has detent means which automatically engage or disengage depending on the pivot direction of the pivot movement when a corresponding actuating force is applied to the carry handle.

18. The storage device according to claim 16, wherein the detent means have at least one nose-shaped locking projection arranged on the container cover.

19. The storage device according to claim 17, wherein the locking projection is arranged on a wall region of the container cover that lies in the region of the housing front side and is formed on the other side of the carry bar of the carry handle than the cover compartment when the carry handle is in the folded-in non-use position.

20. The storage device according to claim 1, characterized by a compartment dividing device for dividing the receiving space of the cover compartment into a plurality of partial compartments.

21. The storage device according to claim 20, wherein the compartment dividing device has a plurality of fixing slots arranged on the receiving space peripheral wall and a plurality of web-shaped partitions that can be releasably inserted into the fixing slots and fixed there.

22. The storage device according to claim 20, characterized by a closure cover securing device for securing the closure cover in its closed position in the region of the closure cover pivot axis on the container cover.

23. The storage device according to claim 20, wherein it comprises a plurality of storage containers, which on their container housing respectively have a lower coupling device in the region of the lower side and an upper coupling device in the region of the upper side, wherein these two coupling devices are adapted to one another in such a way that storage containers stacked directly on top of one another in a vertical direction can be releasably coupled to one another in a manner that prevents them from being separated from each other thanks to the interaction of the upper coupling device of the respective lower storage container and the lower coupling device of the respective upper storage container.
